(19) United States
(12) Patent Application Publication
(10) Pub. No.: US 2014/0072868 A1
(43) Pub. Date: Mar. 13, 2014

(54) Composite Current Collector and Methods Therefor

(71) Applicant: EAST PENN MANUFACTURING CO.,, LYON STATION, PA (US)

(72) Inventor: Frank Lev, Ontario (CA)

(73) Assignee: EAST PENN MANUFACTURING CO.,, Lyon Station, PA (US)

(21) Appl. No.: 14/079,190

(22) Filed: Nov. 13, 2013

Related U.S. Application Data
(63) Continuation of application No. PCT/US2012/037469, filed on May 11, 2012.

(51) Int. Cl. H01M 4/68; H01M 10/04; H01M 10/18

(52) U.S. Cl. CPC H01M 4/68; H01M 10/18; H01M 10/04
USPC 429/210; 29/623.1

(57) ABSTRACT

Contemplated lead acid batteries include a monolithic lead/lead alloy composite foil that is preferably formed by cladding mechanically unstressed lead and lead alloy foils. In such batteries, a light-weight non-conductive grid is placed onto the lead alloy side of the composite foil, which is most preferably pre-treated with a lead-containing adhesive that improves retention of the grid and improves retention and intimate electric contact of the positive active material.

### CROSS-REFERENCE TO RELATED APPLICATIONS

This application is a continuation of PCT International Application No.: PCT/US2012/037469, filed May 11, 2012, which claims priority under 35 U.S.C. §119 to U.S. Provisional Application No. 61/485,984, filed May 13, 2011.

### FIELD OF THE INVENTION

The field of the invention is composite structures for bipole assemblies for a bipolar lead acid battery, and especially current collectors for bipolar lead acid batteries.

### BACKGROUND

Despite their apparent simplicity, bipolar thin film batteries provide numerous significant advantages. For example, as the internal path length is relatively short and as the electrode area relatively large, internal resistance is typically very low, resulting in rapid charge and discharge cycles at minimal heat generation. Moreover, due to their bipolar configuration, the battery weight is reduced and production is at least conceptually simplified. However, several drawbacks have so far prevented widespread use of bipolar lead acid batteries. Among other things, lead is a fairly poor construction material as it creeps under load (i.e., a sheet of lead will slump under its own weight unless attached to a stronger support such as steel), and additional material is often needed to support the lead, resulting in an increased weight. Moreover, creeping of lead typically leads to surface cracking and formation of crevices, which will in most cases accelerate corrosion (stress corrosion).

It is well-known in the art of lead acid battery manufacture that pure lead has a relatively high resistance to corrosion in sulfuric acid containing electrolytes due to the insulating layer of PbSO₄/PbOₓ (1<x<2) that is formed in the electrolyte. Thus, and at least at first glance, it appears desirable to form in a lead battery a positive plate with a current collector grid structure made from pure lead since the PbSO₄/PbOₓ layer acts as semi-permeable membrane and blocks the transport of SO₄²⁻ and/or HSO₄⁻ species. In most cases, the PbSO₄/PbOₓ layer has a thickness of about four microns and tends to stay at that value through the life of a lead acid battery cell, and cells made with pure lead grids experience under most circumstances no corrosion while float-charged.

Where the lead acid battery is a bipolar lead acid battery, it is especially desirable to have a durable and corrosion-resistant substrate. Consequently, pure lead has been considered a prime material for such substrate to capitalize on the protective properties of the PbSO₄/PbOₓ layer. It is known from U.S. Pat. No. 3,806,696 that pure lead grids and pure lead plates can be welded together to provide a composite collector structure in which the resultant weld is of low internal impedance and is relatively thick for increased oxidation and corrosion resistance. Such methods advantageously reduce the resistance at the grid/lead interface. However, lead grid structures from pure lead are unfortunately not suitable for deep cycling applications as the Pb5O4/PbOx layer that is formed during operation also acts as an insulator with very high electric resistance, which in turn results in a premature capacity loss of the cell. To avoid such drawbacks, almost all production battery grids are made of various non-welded lead alloys (e.g., Odyssey lead acid battery, containing at least 0.7% Sn in the lead alloy).

It is also known from U.S. Pat. No. 6,620,551 that the collector for a lead acid battery can be formed from a pure lead substrate and an additional surface layer that comprises a Sb-free lead alloy composition (most typically including an alkaline metal or alkaline earth metal). This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply. While such collectors may reduce or even entirely avoid the formation of the PbSO₄/PbOₓ layer, other disadvantages nevertheless remain. For example, manufacture of such composite structures will often require lamination, electroplating, or welding, which tends to be labor intense and costly in production.

Thus, even though many devices and methods are known for substrates and/or current collectors, there is still a need to provide improved substrates and/or current collectors, and especially for bipolar lead acid batteries.

### SUMMARY

The present invention is directed to bipolar lead acid batteries having a monolithic lead/lead alloy composite foil that is preferably formed by cladding mechanically unstressed lead and lead alloy foils or by low-pressure cold spray deposition. The grid is most preferably a light-weight non-conductive grid or a grid formed from the lead alloy by low-pressure cold spray deposition (LPCS). In still further embodiments, the positive active material and/or the grid is coupled to the composite foil via a lead-containing adhesive (e.g., made from red lead oxide Pb3O4 powder mixed with water and carboxymethyl cellulose) to improve contact of the positive active material and adhesion of the grid to the composite foil.

In one embodiment of the inventive subject matter, a bipole assembly for a bipolar lead acid battery that includes a monolithic lead/lead alloy composite foil that has a first surface and a second surface, and a lead/lead alloy fusion interface between the first surface and the second surface. Most typically, the first surface is formed from the lead and the second surface is formed from the lead alloy. In other embodiments, a non-conductive grid is disposed on the second surface or a grid is formed by the second surface using the lead alloy.

In some embodiments, the lead/lead alloy composite foil is a lead alloy-clad lead foil, and most preferably the lead/lead alloy composite foil has a thickness of equal or less than 0.2 mm. In such embodiments, a polymer grid is employed as the non-conductive grid. In other contemplated embodiments, the second surface is a grid-shaped low-pressure cold spray deposition layer, which in further embodiments includes Ti4O7 particles in the first and/or second surface. Regardless of the configuration of the composite foil, the monolithic lead/lead alloy composite foil may be coupled to a polymer frame via an enhanced sealant.

In further embodiments, a method of producing a bipole assembly for a bipolar lead acid battery includes a step of building a monolithic lead/lead alloy composite foil that has a first surface and a second surface, and a lead/lead alloy fusion interface between the first surface and the second surface. In some methods, the first surface is formed from the lead and the second surface is formed from the lead alloy. In a further step, a grid is coupled to the lead/lead alloy composite foil by placing a non-conductive grid on the second surface, or by forming the grid from the lead alloy to thereby at least partially form the second surface.

In other methods, the lead is provided as a lead foil at a first thickness, and the lead alloy is provided as a lead alloy foil at a second thickness, wherein the first and/or second thicknesses are achieved in a process other than rolling (most preferably casting) the lead foil and/or lead alloy foil. In such methods, the step of building is achieved by cladding the lead foil with the lead alloy foil, and/or a non-conductive grid is coupled to the second surface, wherein the openings in the grid are filled with a pasting device. Alternatively, the step of building may also be achieved by low-pressure cold spray deposition of the lead and/or lead alloy. In such methods, the lead and/or the lead alloy will further comprise Ti4O7 particles. Regardless of the manner of building the composite foil, that the monolithic lead/lead alloy composite foil may be installed into a polymer frame (typically without additional materials for structural support) using an enhanced sealant.

Thus, and viewed form a different perspective, contemplated bipolar lead acid batteries will include a positive end plate and a negative end plate, and a plurality of bipole plates (preferably laser welded together) disposed between the positive and negative end plates. Most typically, at least one of the bipole plates comprises a frame into which a monolithic lead/lead alloy composite foil is sealingly mounted via an enhanced sealant (preferably comprising a silica powder and/or a silane), wherein the monolithic lead/lead alloy composite foil has a first surface, a second surface, and a lead/lead alloy fusion interface between the first surface and the second surface. A positive active material is disposed on the second surface while a negative active material is disposed on the first surface. Most typically, the first surface is formed from the lead and the second surface is formed from the lead alloy, and a non-conductive grid is disposed on the second surface or a grid is formed by the second surface using the lead alloy.

Where the lead/lead alloy composite foil is a lead alloy-clad lead foil, the composite foil may have a thickness of equal or less than 0.2 mm (and that the composite foil is used without further structural support in the frame). Most typically, such devices will include a polymer grid as the non-conductive grid. Alternatively, the second surface may be a grid-shaped low-pressure cold spray deposition layer (optionally comprising comprise Ti4O7 particles, which may also be present in the first surface).

Various objects, features, embodiments and advantages of the inventive subject matter will become more apparent from the following detailed description of embodiments, along with the accompanying drawing figures in which like numerals represent like components.

### BRIEF DESCRIPTION OF THE DRAWINGS

FIG. 1 is an exemplary schematic of a bipolar lead acid battery assembly according to the inventive subject matter.

FIG. 2 is an exemplary schematic of a monolithic lead/lead alloy composite foil with a non-conductive grid, adhesive, and PAM.

FIG. 3 is an exemplary schematic of monolithic lead/lead alloy composite foil with a LPCS-formed grid, adhesive, and PAM.

FIG. 4A depicts a microphotograph at 20× magnification (polarized light) of a cross section of a monolithic composite foil formed from cladding a cast lead foil with a cast lead-tin alloy foil.

FIG. 4B depicts a microphotograph at 20× magnification of the lead surface of the monolithic composite foil of FIG. 4A.

FIG. 4C depicts a microphotograph at 20× magnification of the lead-tin alloy surface of the monolithic composite foil of FIG. 4A.

### DETAILED DESCRIPTION OF THE EMBODIMENT(S)

The inventors have discovered that composite bipole assemblies can be prepared for a bipolar lead acid battery (BLAB) in which the benefits of a Pb—Sn alloy grid and the benefits of a pure lead substrate are combined in an economically and technically desirable manner. In yet further embodiments, the grid may also be formed from a light-weight non-conductive material. Composite bipole assemblies will advantageously comprise a monolithic lead/lead alloy composite foil (most typically without structural support onto which the lead and lead alloy is/are coupled) having a thickness of less than 1 mm, more typically less than 0.5 mm, and most typically less than 0.2 mm.

Moreover, the inventors discovered that where lead and/or lead alloy materials used for bipole assemblies were formed into films or foils using conventional rolling processes, so formed films or foils were subject to sulfuric acid degradation/oxidation at a significantly higher rate than films or foils that were prepared in a manner that reduces or entirely avoids mechanical stress of the lead and/or lead alloy materials. While not wishing to be bound by any specific theory or hypothesis, the inventors contemplate that rolling or stamping the lead and/or lead alloy materials to a desired thickness will stress and enlarge the grain boundaries, and thus provide weakened and/or larger surfaces that are subsequently subject to sulfuric acid degradation/oxidation.

Therefore, methods of manufacture of lead and/or lead alloy materials may include those that will not significantly deform the grain structure (e.g., increase of a single dimension after manufacture to a desired thickness more than 2.5-fold, and more typically more than 3-fold as compared to before manufacture). Consequently, methods of manufacture may include low-pressure cold spray deposition to form a foil or composite foil, and casting of a lead and/or lead alloy foil at a desired thickness without further reducing the thickness (by at least 20%, and more typically at least 50%) of the foil in a rolling or pressing process prior to incorporation of the foil into a composite structure. Where the lead and/or lead alloy foils are cast to a desired thickness, the foils can then be fused to each other in a cladding process to a monolithic composite foil.

As a consequence of the methods of manufacture, the inventors have also discovered that such processes advantageously allow formation of monolithic composite structures that are particularly desirable as such structures will not delaminate as is frequently encountered in laminated composite structures. Additionally, it should be appreciated that the monolithic composite structures also provide ideal conductivity between the lead and/or lead alloy. The term “monolithic” in conjunction with a composite structure is used to mean that the structure includes at least two different materials that are joined to form a continuous interface, typically at which the materials form intermetallic bonds, and wherein the interface does not include a separate binding material disposed between the different materials. Thus, monolithic composite structures will not exhibit delamination along the interface. Most typically, the two different materials will have a sheet or foil configuration (i.e., are generally flat in macroscopic appearance), wherein the sheets or foils have respective opposing surfaces perpendicular to the thickness of the sheet or foil, and wherein one surface of one sheet or foil is joined to one surface of the other sheet or foil.

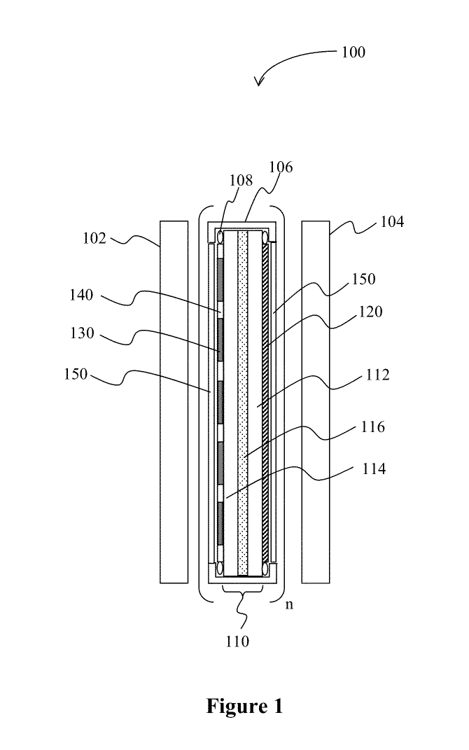

One exemplary bipolar lead acid battery assembly is schematically shown in FIG. 1 where battery assembly 100 has a positive end plate 102 and a negative end plate 104, and a plurality of bipole plates (n) disposed between the positive and negative end plates. Each of the bipole plates has a frame 106 into which a monolithic lead/lead alloy composite foil 110 is sealingly mounted using an enhanced sealant 108 that preferably includes silica powder and/or a silane. The monolithic lead/lead alloy composite foil 110 has a first surface 112 formed from a lead foil, a second surface 114 formed from a lead alloy foil, and a lead/lead alloy fusion interface 116 between the first and second surfaces. A non-conductive grid 140 is disposed on the second surface, or grid 140 is formed by the second surface using the lead alloy as further described below. Positive active material (PAM) 130 is disposed on the second surface, and negative active material (NAM) 120 is disposed on the first surface. Compression resistance separators 150 comprising gelled electrolyte (not shown) are placed on the PAM and NAM.

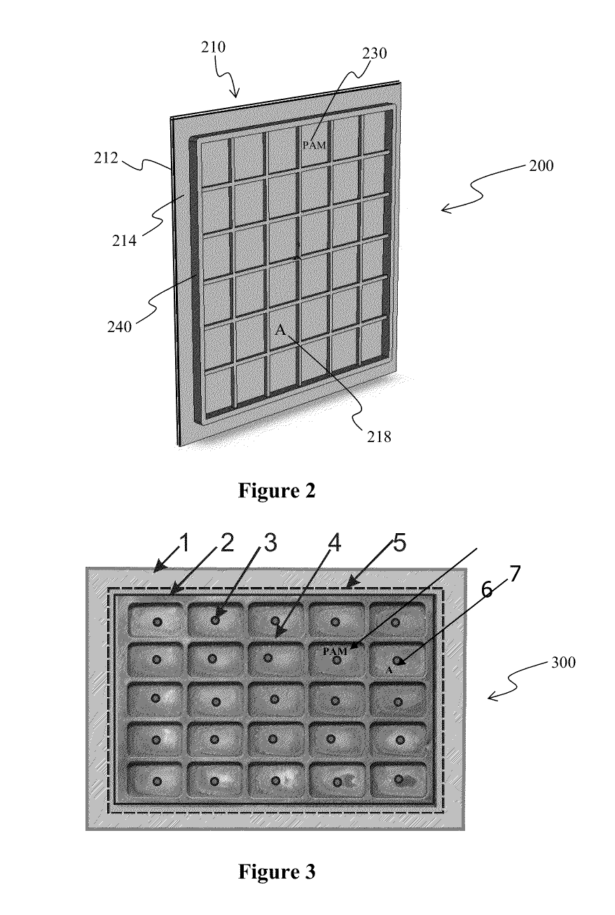

FIG. 2 schematically illustrates one embodiment where the monolithic composite lead/lead alloy foil is a lead alloy-clad lead foil, and where the grid is a non-conductive light-weight polymer grid. Here, the bipole assembly 200 includes monolithic composite lead/lead alloy foil 210, having first surface 212 from the lead foil and second surface 214 from the lead alloy foil. Here, the lead foil and the lead alloy foil are cast foils each having a thickness of about 0.254 mm. After cladding, the monolithic composite lead/lead alloy foil has a thickness of about 0.152 mm. In embodiments, the PAM 230 is retained by grid 240, and a lead-containing adhesive 218 forms a layer on second surface 214 to help adhesively retain grid 240 on the second surface as well as to provide improved electrical and mechanical contact of the PAM 230 to the second surface 214.

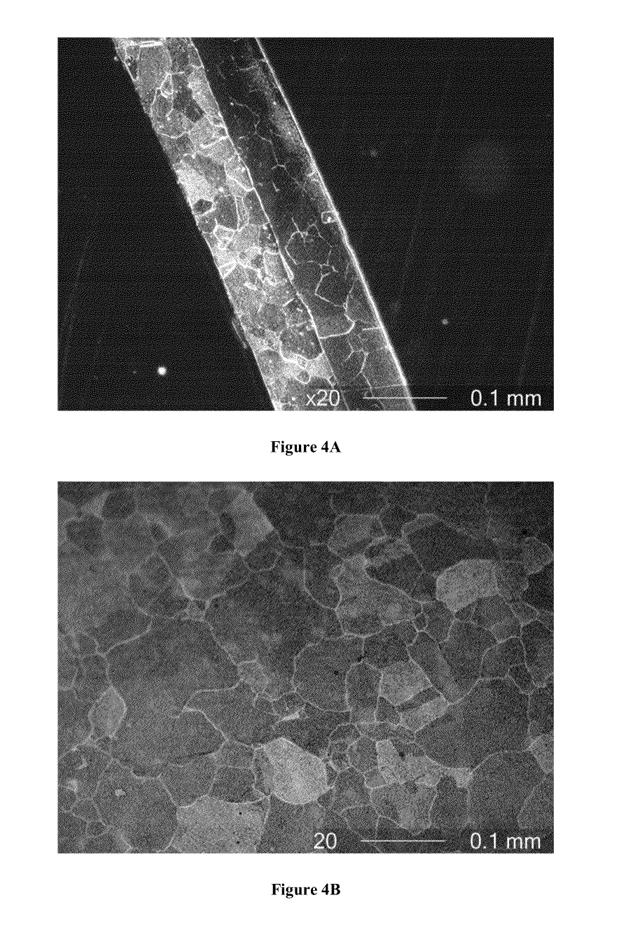

Alternatively, as schematically shown in FIG. 3, the monolithic composite lead/lead alloy foil is formed by LPCS. Here, the bipole assembly 300 has a frame portion 1 retaining a lead foil 2 on which grid 4 is formed via LPCS. Thus, the assembly will have a first surface formed by the lead foil 2 and a second surface formed by the lead alloy grid 4. Where desired or where the lead foil is supported on a solid carrier (e.g, metal or plastic plate), the current is collected from the PAM 6 to lead foil 2 via electrically conductive joints 3 (which may also be formed by LPCS), thus effectively bypassing the high resistivity PbSO₄/PbOₓ layer on the substrate. In such composite foils, it is that the lead and/or the lead alloy may further comprise Ti₄O₇ particles (not shown). As before, the PAM can be installed on the grid using the lead-containing adhesive. Remarkably, using contemplated methods presented herein allowed the manufacture of composite collectors with numerous desirable properties, even where the lead foil and grid were relatively thin (e.g., 0.15 mm). Moreover, the grid in such devices was homogeneously connected to the foil, which is particularly difficult to achieve with collectors having a thin substrate to which a grid is coupled.

With respect to the lead materials, the inventors observed that weight loss data could be indicative that mechanically stressed/deformed alloys, and especially lead alloys that have been rolled from a stock material to a desired thickness, corrode faster than cast alloys at all temperatures. Therefore, and using a hypothesis that increased mechanical stress/deformation leads to higher corrosion rates and more exposed grain boundaries, the inventors investigated suitability of mechanically unstressed lead and lead alloy foils in the preparation of bipole assemblies. The inventors then discovered that mechanically unstressed lead and lead alloy foils are particularly beneficial for the manufacture of bipole assemblies. In embodiments, such materials especially included lead and lead alloy foils that were cast on a commercially available casting machine to a desired thickness, where the desired thickness is within +/−25%, more typically within +/−10%, and most typically within +/−5% of the final thickness of the lead or lead alloy foil immediately prior to forming the composite structure. Viewed from a different perspective, the lead and lead alloy foils are preferably cast to thickness without rolling to further reduce thickness of the foils. Thus, it should be appreciated that the metal grains will have reduced dimensional stress, typically such that the longest dimension is less than four times, more typically less than three times, most typically less than 2.5 times the smallest dimension. So prepared lead and lead alloy foils are then used to form a composite structure, and most preferably a monolithic composite structure.

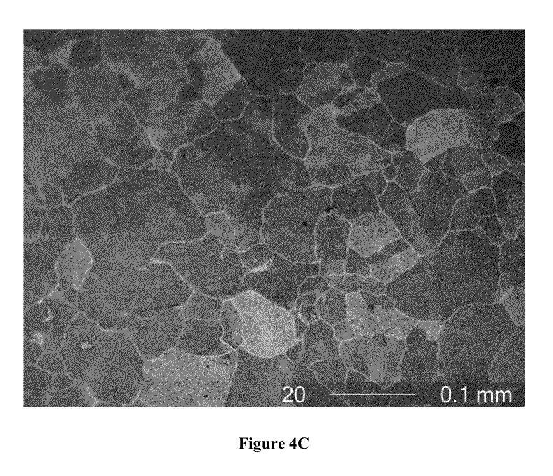

As is readily apparent from FIGS. 4A-4C, the lead/lead-alloy composite foil has a homogenous and tight interface showing intermetallic bonding between the foil layers without delamination, and further clearly illustrates the mechanically unstressed morphology of the grains. FIG. 4A depicts a microphotograph at 20× magnification (polarized light) of a cross section of a monolithic composite foil formed from cladding a cast lead foil with a cast lead-tin alloy foil. FIG. 4B depicts a microphotograph at 20× magnification of the lead surface of the monolithic composite foil of FIG. 4A. FIG. 4C depicts a microphotograph at 20× magnification of the lead-tin alloy surface of the monolithic composite foil of FIG. 4A. In such composite foils, it has been shown that the lead and lead foils were bonded to each other along an interface of a randomly chosen cross section in typically at least 95%, more typically at least 97%, and most typically at least 99% of the length of the interface. Such remarkably high bonding resulted in superior mechanical and electrical performance characteristics.

For example, in one embodiment of the inventive subject matter, a lead foil and a lead alloy foil are clad together to form a monolithic lead/lead alloy composite foil. In such process, the lead particles are clad at about 600 psi contact pressure, at which lead melts and produces intermetallic bond. Of course, it should be appreciated that the contact pressure may vary considerably within the confined of cladding. Thus, typical contact pressures will be in the range of about 500 psig to 900 psig, at temperatures of between about 4° C. and 150° C. While not limiting to the inventive subject matter, it is also contemplated that the cladding process is performed using the cast lead foil and lead alloy foil in a Tory Crane-type cladding and that the so produced monolithic lead/lead alloy composite foil has a thickness that is less than the additive thickness of the lead foil and lead alloy foil.

For example, the cast foils will typically have a thickness of between 0.01 mm and 10 mm, more typically between 0.1 and 1.0 mm, and most typically between 0.2 and 0.3 mm. Upon cladding, the monolithic lead/lead alloy composite foil will have a thickness that is equal or less than 80% of the additive thickness of the lead and the lead alloy foil, more typically equal or less than 50% of the additive thickness of the lead and the lead alloy foil, and most typically equal or less than 25% of the additive thickness of the lead and the lead alloy foil. For example, a thickness for the lead and lead alloy foil before cladding may be about 0.254 mm, while the monolithic lead/lead alloy composite foil has a final thickness of about 0.1524 mm. It should also be noted that the lead foil and the lead alloy preferably have the same thickness (prior to cladding). However, in alternative embodiments, one foil may be thicker or thinner than the other. Still further, it is contemplated that more than two foils can be clad together, and suitable additional foils include foils from metallic material (e.g., copper, silver, aluminum, etc.) as well as non-metallic materials (e.g., conductive polymers). However, it is generally preferred that no stabilizing layer or other functional layer is disposed between the lead and the lead alloy foil in the clad product.

With respect to the purity of the lead foil, the lead may be of high purity, to comprise at least 99 wt %, and more typically 99.9 wt % metallic lead. However, in embodiments, the lead foil may also include additional materials, which may be present as ‘impurities’, or which may be added to a lead preparation (e.g., Magneli phase suboxides). Similarly, it should be noted that the lead alloy foil may include numerous alloying metals known in the art. However, allying metals may include tin and calcium. With respect to tin, it should be recognized that the corrosion rate of a lead tin alloy will depend on the tin content. The inventors have determined that the optimal tin content in a lead alloy foil is 1.8 wt %, which afforded the lowest corrosion rate. Pb-1.8% Sn has less corrosion resistance than pure lead, however, is particularly beneficial for deep cycling. Using 1.8 wt % of tin will provide relatively limited surface corrosion with only sporadic pitting. However, as sulfuric acid will infiltrate sporadic pin holes, corrosion will be stopped by formation of a Pb-foil passive layer.

Where the monolithic lead/lead alloy composite foil is manufactured by cladding, the grid may be made from a non-conductive material and placed onto the first and/or second surface of the monolithic lead/lead alloy composite foil. Where the grid is placed onto the first surface, the grid will generally be configured to provide a non compressible NAM spacer. Where the grid is (also) placed on the second surface, the grid will be configured to serve as a light, low foot print carrier akin to the conventional lead grid to facilitate pasted electrodes. In this respect, it should be appreciated that the grid can be configured to allow pasting and curing on conventional automatic pasting equipment. The benefit of this method is relative simplicity and cost effectiveness of manufacturing positive and negative electrodes on existing high volume equipment. Thus, suitable non-conductive grid materials will include thermoplastic and thermosetting polymers, and especially polyethylene (PE), high-density polyethylene (HDPE), acrylonitrile-butadiene-styrene (ABS), various polyacrylates (PA), polycarbonates (PC), and polypropylenes (PP), poly(methyl methacrylate) (PMMA), polystyrene (PS), and polybutylene terephtalate (PBT).

In another example, the monolithic lead/lead alloy composite foil can also be made using an LPCS process to not only deposit a lead alloy layer onto the lead layer (which may also be formed by LPCS), but to also achieve a monolithic construction and to build the grid. Consequently, it should be appreciated that bipolar composite structures can be formed at least in part by LPCS deposition of conductive materials in which a spray formed composite current collector combines the advantages of improved resistance to oxidation with low cost of manufacturing.

Composite current collectors of some devices and methods are produced such that the collector has an alloyed grid portion (most typically Pb—Sn alloy) that is structurally and conductively continuous with a pure lead substrate. The lead substrate may contain an additional core layer (most preferably of copper) to increase electric conductivity of the current collector. Remarkably, using contemplated methods presented herein allowed the manufacture of composite collectors with numerous desirable properties, even where the lead foil and grid were relatively thin (e.g., 0.15 mm). Moreover, the grid in such devices was homogeneously connected to the foil, which is particularly difficult to achieve with collectors having thin substrate and grid.

Based on experiments using commercially available LPCS equipment, the inventors discovered that when a pure lead substrate (e.g., thin lead foil with a purity of at least 99 wt %) is sprayed at low temperatures (e.g., less than 300° C., more typically less than 250° C., most typically less than 200° C.) with a Pb—Sn alloy powder (e.g., 1.5 wt % Sn, 98.5 wt % Pb), the deposited alloy layer appeared dense and exhibited good bonding/cohesive properties. There was no evidences of oxidation, distortion, residual stresses and/or undesirable metallurgical transformations, and the resulting deposits had adequate mechanical strength and electrical conductivity between the substrate and the deposited material. Coatings were produced by entraining Pb—Sn metal powder mixtures in an accelerated air stream through a converging-diverging de Laval nozzle and projecting them against a target substrate. The particles were accelerated to supersonic velocity by the stream of compressed air. In most embodiments, the particles were solid (not melted) prior to impingement onto the substrate. Thus, LPCS deposition can be used to produce thick and dense coatings with high adhesion due to significantly reduced compressive stress between the coating and the substrate.

In an effort to produce a suitable grid structure on the surface of a substrate, the inventors used various masking materials to prevent the metal spray to adhere to undesirable areas of the substrate, and suitability to high volume manufacturing was a masking material criterion. Relatively good results were received with application of masking stencils made of commercially available 5 mil thick self-adhesive vinyl tape, which not only avoided laborious and costly conventional processes to conductively couple the grid to the substrate, but also allowed formation of the composite structure in many configurations and geometries in a highly automated and simple manner. The term “formed” as used in conjunction with the LPCS production of a grid and/or substrate means that the grid and/or substrate is produced in a gradual and additive process where material is added to the nascent grid and/or substrate to so arrive at the final grid and/or substrate structure.

Thus, it should be recognized that the inventors contemplate various bipolar electrode assemblies for use in bipolar lead acid batteries, and that such assemblies advantageously include one or more composite current collectors in which a conductive substrate is formed from a first metal composition (typically pure lead) and in which a grid structure is formed from a second metal composition (typically a Pb—Sn lead alloy). Most preferably, contemplated devices are produced with the help of a low temperature spraying process in which the spray materials are not melted in the spray gun, but rather kinetically deposited on the substrate at low temperatures in a process similar to the one described in U.S. Pat. No. 6,139,913 and U.S. Pat. App. No. 2003/0077952A1. The resulting deposits are dense and with good bonding/cohesive strength, however, had a relatively slow deposition rate of Pb—Sn powder. Moreover, such materials a mechanically not stressed and will exhibit superior performance characteristics.

Based on several experiments, the inventors recognized that the deposition rate strongly depended on the susceptibility of the spray nozzle to clogging, which required frequent cleanups. While it was generally known that addition of harder particles (e.g., aluminum oxide) to softer powders may produce a desired cleaning effect on a nozzle, currently known additives are typically not suitable for use in the current collector structures as these materials tend to negatively impact mechanical and/or electrical parameters (e.g., reduction of overall conductivity of the deposited material). After numerous experiments with various materials the inventors discovered that a relatively small addition of Ti₄O₇ (Ebonex) powder to the Pb and/or Pb—Sn powder reduces nozzle clogging while keeping impedance of the deposited metal layer only fractionally higher than the material free of the additive. It was further discovered that the Ti₄O₇ particles will preferably have size of 1-150 microns (largest dimension) and an aspect ratio of between about 10:1 and 1:1. It is also generally desirable that the particles are present in an amount of between 0.05 to 5 weight % to the Pb and/or Pb—Sn particles.

With respect to the Pb or Pb—Sn particles, the particles may have an average size of between about 10-200 microns (largest dimension) with an aspect ratio of between about 20:1 and 4:1. Based on the above considerations and methods, the inventors could efficiently deposit Pb and/or Pb—Sn material on a pure lead or lead alloy substrate at a high production rate (e.g., average speed of deposition about 0.82 kg/h) while achieving a maximal relatively uniform height (thickness) of deposited material of about 200 micron. Adhesion of the deposited material appeared to be within a desirable range of 20 to 80 MPa. Indeed, the inventors found, while conducting tensile tests, that in most cases the Pb foil broke sooner than the cold sprayed layer of material. Also, the sprayed coatings appeared dense, with low porosity. For example, a 5 by 5 mm section of a deposited Pb—Sn bid on a Pb foil of 0.15 mm thickness was encapsulated in epoxy and polished for inspection. Porosity appeared to be within 2-3%. Thus, the inclusion of Ti₄O₇ additive did not appear to compromise the mechanical qualities of the deposited material.

With respect to the substrate, it is contemplated, that the substrate comprises lead or is made entirely from lead and has a generally planar and relatively thin configuration. Thus, in most embodiments of the inventive subject matter, the substrate is a pure lead foil having a thickness of between about 2 mm and 0.05 mm. The lead substrate may also be modified to include elements other than lead to so increase stability against oxidation, or may be a lead alloy to impart desirable characteristics. It should be noted, that where the lead foil is very thin (e.g., equal or less than 0.1 mm) or has a planar area in excess of 200 cm², a conductive and/or non-conductive carrier may be implemented to stabilize the structure. For example, suitable carriers include non-conductive and oxidation resistant polymeric materials (e.g., synthetic polymers such as PC, HDPE, and other polymers known in the battery art). Regardless of the nature of the carrier, it is typically preferred that the carrier is relatively thin (e.g., having a thickness of between 0.1 and 100 times the thickness of the substrate) and is capable of retaining the substrate. Thus, suitable carriers may be laminated to the substrate (see e.g., U.S. Pat. No. 5,510,211, describing a bipolar battery substrate as a composite current collector comprising a porous nonconductive (e.g., ceramic) substrate impregnated with lead to form a multi channeled conductive path through the substrate). Thus, various methods are suitable to produce a conductive path, including saturation with molten lead, electrolytic precipitation, or embracing large number of parallel strings of lead with molten polymer. It must be noted, that all of these methods may be used to reliably embedded conductors into a non-conductive and electrochemically stable matrix, where that matrix has conductive planar surfaces on opposing sides of the matrix, and wherein the conductive planar surfaces are made of lead or lead alloy and are electrically connected to the multiple conductors. The inventors further discovered that desirable results are produced where a non-conductive and oxidation resistant carrier made of polymeric materials, preferably thin fiberglass foil (e.g., having a thickness of between 0.1 to 3.0 mm) is perforated with plurality of small diameter holes that allow inclusion of pure lead to transfer electrons from one side of the carrier to the other side. Most preferably, the holes are implemented at a rate of about two holes per square centimeter of the carrier planar surface where the holes have an average diameter of about 100 to 150 micron in diameter. Remarkably, the combined area of the so included lead will have a conductivity comparable or better than the best battery grids of conventional design, however with the benefit of being considerably lighter and possibly less expensive than most known devices. It should be noted that the inventors also unexpectedly discovered that the sprayed particles of lead are sufficiently imbedded into plastic material to so provide reliable cohesion with the carrier, which completely eliminated the need for laminating.

In still other embodiments of the inventive subject matter, it is contemplated that the conductive planar surfaces of the composite current collector may be (cold) sprayed onto the carrier. Additionally, or alternatively, it may also be beneficial to use the cold spray deposition to fill in the perforated holes with pure lead, and to deposit a layer of pure lead on the negative side of the carrier and a layer of Pb—Sn alloy on the positive side thereof. In such and other devices, the negative layer will have a thickness of about 50 to 75 micron, and the positive layer will have a thickness of about 75 to 150 micron to so provide sufficient conductivity and corrosion reserve. Moreover, it should be recognized that a layer of pure lead may be deposited and then a Pb—Sn grid structure is formed on the lead layer without a non-conductive carrier. It should be noted that irrespective of the composite current collector design, a material for the grid or positive planar conductor is a binary lead alloy comprising 0.4 to 0.9 wt % Sn with the balance of pure Pb.

Therefore, and at least in part depending on the choice of materials, it is also possible that the grid structure without a carrier and/or the entirety of the conductive structure may be formed by LPCS to so produce a monolithic composite structure. The exact configuration of the conductive structures will depend on the size and configuration of the substrate, and will further depend on the particular use of the battery. Regardless of the particular configuration, the substrate may have at least a 3 mm, preferably 5 mm wide flange (i.e., area free of the grid) to allow encapsulation into a (typically plastic) frame as was previously described in our co-pending WO2010/135313.

Regardless of the manner of manufacture of the monolithic lead/lead alloy composite foil (e.g., LPCS or cladding of cast foils), the composite foil may be installed into a preferably non-conductive frame, most preferably such that the composite foil is placed between two frame half-portions that engage with the perimeter of the composite foil. With respect to suitable frame materials it should be appreciated that various materials are deemed suitable, and materials include light-weight materials that may or may not be conductive. For example, light-weight materials include various polymeric materials, carbon composite materials, light-weight ceramics, etc. However, other materials include those suitable for thermoplastic laser welding. For example, contemplated thermoplastic material include acrylonitrile-butadiene-styrene (ABS), various polyacrylates (PA), polycarbonates (PC), and polypropylenes (PP), poly(methyl methacrylate) (PMMA), polystyrene (PS), and polybutylene terephtalate (PBT), which may be reinforced with various materials, and especially with glass fibers.

Where the frames are laser welded together, the material choice in this instance is only limited by the plastic to be laser penetrable at least at some point in the welding and/or assembly process. Furthermore, it is noted that where the polymer is completely transparent, pigments (internal or external) may be used to absorb the laser energy to thereby facilitate welding. However, the manner of fusion of the frames need not be limited to laser welding, but can vary considerably and include spot and seam welding, ultrasonic welding, chemical welding using activated surfaces (e.g., plasma etched surfaces), and use of one or more adhesives.

In further embodiments of the inventive subject matter, an enhanced adhesive is used to seal the composite foil with the frame. Enhanced adhesives can be prepared from commercially available epoxy adhesives to which a viscosity enhancer is added. Among other suitable choices, viscosity enhancers include commercially available SiO₂ fumed silica powder. By adding such powder at about 2% to 8% by weight, and more typically 4% to 5% by weight to commercially available epoxy components, the inventors produced a sealer compound that proved to be impervious to electrolyte and electrolytic shunts through 390 cycles at C/2 to 80% DOD to 70% of initial capacity. Binding and sealing capacity between the composite foil and the frame could even be more improved by adding a coupling agent to the adhesive. Among other agents, the inventors discovered that commercially available silane performed exceptionally well, and quantities of the coupling agents were between 0.1 and 5 wt %, and between 1 and 3 wt %. Thus, it should be appreciated that the interface between the monolithic composite foil and the frame can be reliably sealed using an enhanced adhesive in which a conventional adhesive (e.g., epoxy adhesive) has been modified by one or more additives to increase viscosity and adhesion to the substrate. Such enhanced adhesives have proven to be impervious to electrolyte migration over extremely long periods and typically outlasted the design life of the battery.

With respect to suitable PAM, it is noted that all known PAM are deemed appropriate for use in conjunction with the teachings presented herein. Therefore, lead dioxide is most typically the PAM of choice. Furthermore, the inventors have made a cement composition that comprises red lead oxide (Pb3O4) powder mixed with water and carboxymethyl cellulose as a binder. The so produced cement has a consistency of honey and is deposited on the lead alloy surface prior to placing the positive non-conductive electrode. Moreover, the cement also is used to enhance adhesion and provide full contact between the positive electrode material and the composite foil. The inventors have unexpectedly discovered that the CMC binder (e.g., added to the oxide mix in 0.05% by weight) provides sufficient adhesion to retain the electrode material in full contact with the foil when it is dry. The red lead oxide is known for its quality to improve formation and is customarily added to the leady oxide pastes for that purpose alone. In contrast, the PAM paste in present batteries will not contain red lead oxide and is mated with the foil being dry after curing. In currently known batteries, and despite the sufficient compression of the electrodes, it is hard to expect a full contact between the foil and the electrode to develop even after saturation of the former with electrolyte. In contrast, the lead oxide cement presented herein provides an intimate contact between the electrode and the foil, and will also retain the electrode in place and prevents its delamination from the foil at assembly. Thus, using the lead oxide cement, the formation initiation voltage is reduced, which in turn reduces galvanic corrosion of the foil during formation.

Recognizing the critical role of the grid-to-PAM interface under deep cycling duty, an optimization relationship between the weight of PAM (W_{PAM}) and area of the grid (S_{grid}) that is in contact with PAM was established in which β is defined as W_{PAM} S_{grid} in a positive half cell. Among other grids produced, especially suitable experimental grids had a β value of between about 0.5-1.3 g/cm², more preferably between about 0.65-1.1 g/cm², and most preferably between about 0.8-1.0 g/cm², whereas a typical SLI (Start, Light, Ignition) battery is considered to have a β value of about 2.5 g/cm². In further experiments, the grid portion of the collector structure was designed to a β value of about 0.95 g/cm2 (using 42 g of PAM and 44 cm2 total area of grid wires in contact with PAM). Remarkably, in such and the above grids and substrates, sufficient area of the current collecting surfaces was present to achieve uniform distribution of the PAM in contact with the grid wires to improve the utilization of PAM and increase cycle life, particularly for deep cycle operation. As used herein, the term “about” in conjunction with a numeral refers to a range of that numeral of +/−10%, inclusive. Furthermore, and unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

Similarly, with respect to suitable negative active materials (NAM) it should be appreciated that all known NAM are considered appropriate for use herein. Thus, especially contemplated NAM includes various lead-based pastes. The NAM is preferably retained at the substrate using a non-conductive carrier (grid) that is most preferably compression resistant. While not limiting to the inventive subject matter, the non-conductive grid is preferably manufactured from a synthetic polymer that is resistant to acid and oxidative corrosion. Preferably, such grid (e.g., skeletal structure) will advantageously have the same height as the NAM thickness at fully charged state. Therefore, the bipole can be compressed at both sides to a desirable pressure without negatively affecting the electrode performance. However, it should be noted that conductive grids are also considered suitable for use herein.

Particularly batteries will also comprise a compression resistant separator that retains the electrolyte in a gelled form, which not only allows for substantial compression of the cell stack (thus eliminating shedding of positive active materials), but also allows for operation of the battery without problems associated with electrolyte migration (even where the bipole fails to have any seal to protect against solvent migration). In some methods and devices, the separator of the batteries comprises a material that gels the electrolyte and so prevents leakage around the bipole. Most preferably, such separators are configured to withstand compression to still further improve operational parameters of the battery.

Consequently, it should be appreciated that a bipolar (and most preferably a valve regulated bipolar) lead acid battery can be produced in which a first and a second bipolar electrode assemblies are separated by a compression resistant separator in which an electrolyte is retained in a gelled form. Viewed from a different perspective, contemplated batteries will have a first and second compression resistant separator coupled to the layer of positive active material and the layer of negative active material, respectively, wherein first and second compression resistant separators comprise the electrolyte in a gelled form.

The term “compression resistant separator” as used herein refers to a separator that can withstand mechanical compression of at least 30 kPa in a battery stack without loss of thickness or with a loss in thickness that is equal or less than 10%. Most typically, however, compression resistant separators may withstand pressures of at least 50 kPa, and even more typically at least 100 kPa in a battery stack with a loss in thickness that is equal or less than 10%, more preferably equal or less than 5%, and most preferably equal or less than 3%. Consequently, some separators will comprise ceramic or polymeric materials suitable to withstand such pressures.

Moreover, the separators according to the inventive subject matters also may have the capability to retain the electrolyte while in contact with the active materials of the battery. Such capability is preferably achieved by retention of the electrolyte in a gelled form, wherein all known gelling agents are deemed suitable for use herein. For example, suitable gelling agents may be organic polymers or inorganic materials. In one embodiment of the inventive subject matter, the electrolyte is immobilized in a micro-porous gel forming separator to so prevent conductive bridges between the positive and negative sides of the bipole and thus enables the bipolar battery to have a calendar and cyclic life comparable or better than that of a conventional lead acid battery.

Among other appropriate separators, the inventors have discovered that an AJS (acid jelling separator) (e.g., commercially available from Daramic, LLC) was not only capable of withstanding compressive forces but also capable of arresting migration of the electrolyte beyond the electrode boundary. Indeed, the inventors discovered that using such electrolyte immobilization a bipolar lead acid battery can be made that can continuously operate (i.e., over several charge/discharge cycles) without any sealing of the cells in the battery. The Daramic AJS is a synthetic micro-porous material filled with 6 to 8 wt % of dry pyrogenic silica. When the AJS is saturated with 1.28 s.g. (specific gravity) electrolyte, its silica component reacts with the latter to form a gel. Thus, it is contemplated that the electrolyte becomes immobilized by hydrogen bonding or Van-der-Waals forces of gel and/or by pores in the separator such that even in air nothing leaks. The limited mobility of the gel electrolyte prevents conductive bridges to occur between the positive and negative sides of the bipole. Further suitable materials are described in U.S. Pat. No. 6,124,059, which is incorporated by reference herein. However, in alternative embodiments of the inventive subject matter, it is noted that all combinations of dimensionally stable materials (i.e., materials that can withstand compression at forces of 100 kPa at a loss of thickness of less than 10%, and more preferably less than 5%) with a gelled electrolyte are considered suitable for use herein.

It should be especially appreciated that a further important advantage of the AJS material is its very limited dimensional yield under the compression force that are typically applied to the bipoles in lead acid batteries, and especially VRLAs. Unlike the ordinarily used AGM (fibrous absorbent glass mat) separators that often yield under compression, the AJS material allows compression the active materials to the desired pressure of 30 to 100 kPa, and even higher.

While such compression is desirable for positive active material (PAM, typically made from a combination of lead oxides and basic lead sulfates) to mitigate its shedding, it is detrimental to negative active material (NAM) by reducing its porosity and thickness. To circumvent at least some of the problems associated with NAM compression, the inventors have incorporated a skeletal structure to which the NAM is coupled and which has contact with the negative electrode surface.

In some embodiments of the inventive subject matter, the skeletal structure comprises a grid that is made of a glass fiber mesh of the thickness equal to the thickness of the NAM. The negative paste is then filled into the cavities of the mesh even with its surface facing the separator (there is no over-pasting of the grid wires). Such design enables sheltering of the NAM from the compression exerted by the AJS. The AJS, while having a good interface with NAM, is stopped from exerting the force on the latter. Of course, it should be noted that numerous alternative skeletal structures are also suitable, including a perforated plate and other porous and structurally stable materials (typically non-conductive). Most preferably, the skeletal structure is made of a material that is stable in sulfuric acid and has the required mechanical properties (e.g., thermoplastic materials such as ABS, PP, or PC). The skeletal material will typically have the same thickness as the NAM at the 100% state of charge to so act as a buttress between a separator NAM contained in the void space of the skeletal material.

With respect to suitable valves, it should be noted that all known valves and valve installations are deemed suitable for use herein. However, some valves and valve installations comprise unidirectional valves (e.g., duckbill valve) to so provide a one-way relieve feature for individual cells, preferably into a vented collecting channel, while not allowing gas from the cell or channel to get into the other cells. Such valves noticeably improve the voltage balance of the cells during charging.

Consequently, it should be recognized that bipolar batteries, and especially VRLAs with high power densities can be produced in a simple and cost-effective process that will not only significantly reduce use of metallic weight but also substantially eliminates electrolyte creep and/or loss and problems associated with delamination and oxidative damage.

Furthermore, it should be particularly noted that contemplated devices and methods will typically not require retooling or dedicated equipment, but can be produced using most if not all of the currently existing production equipment and processes. Once assembled, the battery can then be filled with electrolyte and undergo a process of formation, which may be performed “in-container”(e.g., for relatively small VRLA batteries with the bipoles installed in the housing) or “in-tank” (where the grid and active materials are separately subjected to formation in an electrolyzer). However, it should be appreciated that the batteries presented herein are suitable for both processes. Therefore, batteries with remarkably improved performance and reliability can be made in a simple and economic manner.

Moreover, it should be appreciated that due to the light-weight construction batteries with significant improved specific energy can be produced. For example, using contemplated devices and methods, valve regulated lead acid batteries having a metallic lead and/or metallic lead alloy content of equal or less than 10 g/Ah, more typically equal or less than 8 g/Ah and most typically equal or less than 6 g/Ah (in fully discharged condition), and a specific energy content of at least 45 Wh/kg, more typically at least 50 Wh/kg, and most typically at least 54 Wh/kg can be produced. Among other types of batteries, VRLA batteries include general purpose batteries, SLI (starting, lighting, ignition) batteries, UPS (uninterruptible power supply) batteries, and batteries for transportation (hybrid or electric car batteries, etc.). Further embodiments, configurations and methods suitable for use in conjunction with the teachings presented herein are disclosed in our cop ending International patent applications WO 2010/019291, WO 2010/135313, and WO 2011/109683, all of which are incorporated by reference herein.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A bipole assembly for a bipolar lead acid battery, comprising:
a monolithic lead/lead alloy composite foil having a first surface and a second surface, and a lead/lead alloy fusion interface between the first surface and the second surface;
wherein the first surface is formed from the lead and wherein the second surface is formed from the lead alloy; and
a non-conductive grid disposed on the second surface, or a grid formed by the second surface using the lead alloy.

2. The bipole assembly of claim 1 wherein the lead/lead alloy composite foil is a lead alloy-clad lead foil.

3. The bipole assembly of claim 1 wherein the lead/lead alloy composite foil has a thickness of equal or less than 0.2 mm.

4. The bipole assembly of claim 1 wherein the second surface is a grid-shaped low-pressure cold spray deposition layer.

5. The bipole assembly of claim 1 wherein at least one of the first and second surfaces further comprise Ti4O7 particles.

6. The bipole assembly of claim 1 further comprising a layer of a lead oxide containing adhesive disposed between the second surface and at least one of the non-conductive grid and a positive active material.

7. The bipole assembly of claim 1 further comprising a polymer frame (106) to which the monolithic lead/lead alloy composite foil is coupled via an enhanced sealant.

8. A method of producing a bipole assembly for a bipolar lead acid battery, comprising:
building a monolithic lead/lead alloy composite foil having a first surface and a second surface, and a lead/lead alloy fusion interface between the first surface and the second surface;
wherein the first surface is formed from the lead and wherein the second surface is formed from the lead alloy; and
coupling a grid to the lead/lead alloy composite foil by placing a non-conductive grid on the second surface or by forming the grid from the lead alloy to thereby at least partially form the second surface.

9. The method of claim 8 wherein the lead is provided as a lead foil at a first thickness, wherein the lead alloy is provided as a lead alloy foil at a second thickness, and wherein at least one of the first and second thickness is achieved in a process other than rolling the at least one of the lead foil and lead alloy foil.

10. The method of claim 9 wherein the step of building is achieved by cladding the lead foil with the lead alloy foil.

11. The method of claim 8 further comprising step of forming a layer of a lead oxide containing adhesive between the second surface and at least one of the non-conductive grid and a positive active material.

12. The method of claim 8 wherein the step of building is achieved by low-pressure cold spray deposition.

13. The method of claim 8 wherein at least one of the lead and the lead alloy further comprise Ti4O7 particles.

14. The method of claim 8 further comprising a step of installing the monolithic lead/lead alloy composite foil into a polymer frame using an enhanced sealant.

15. A bipolar lead acid battery, comprising:
a positive end plate and a negative end plate, and a plurality of bipole plates disposed between the positive and negative end plates;
wherein at least one of the bipole plates comprises a frame into which a monolithic lead/lead alloy composite foil is sealingly mounted via an enhanced sealant, wherein the monolithic lead/lead alloy composite foil has a first surface, a second surface, and a lead/lead alloy fusion interface between the first surface and the second surface;
wherein the first surface is formed from the lead and wherein the second surface is formed from the lead alloy;
a non-conductive grid disposed on the second surface or a grid formed by the second surface using the lead alloy;
wherein the enhanced sealant comprises at least one of a silica powder and a silane; and a positive active material disposed on the second surface and a negative active material disposed on the first surface.

16. The bipolar lead acid battery of claim 15 wherein the lead/lead alloy composite foil is a lead alloy-clad lead foil having a thickness of equal or less than 0.2 mm.

17. The bipolar lead acid battery of claim 16 further comprising a layer of a lead oxide containing adhesive disposed between the second surface and at least one of the non-conductive grid and the positive active material.

18. The bipolar lead acid battery of claim 15 wherein the second surface is a grid-shaped low-pressure cold spray deposition layer.

19. The bipolar lead acid battery of claim 18 wherein at least one of the lead and the lead alloy further comprise Ti4O7 particles.

20. The bipolar lead acid battery of claim 15 wherein the enhanced sealant comprises the silica powder and the silane, and wherein the frame has a laser weld with at least one additional frame.
